(19) United States
(12) Patent Application Publication
(10) Pub. No.: US 2010/0201078 A1
(43) Pub. Date: Aug. 12, 2010

(54) SEALING DEVICE

(75) Inventors: Yoshihiro Kuzumaki, Fukushima-shi (JP); Yuichi Shuto, Fukushima (JP); Yoshimi Imamoto, Fujisawa-shi (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/439,808

(22) PCT Filed: Oct. 5, 2007
(86) PCT No.: PCT/JP2007/069545

§ 371 Date: Mar. 3, 2009

(30) Foreign Application Priority Data
Oct. 16, 2006 (JP) 2006-281240

(51) Int. Cl. F16J 15/32

(52) U.S. Cl. 277/560

(57) ABSTRACT

A sealing device includes a side lip contacting with a surface angled to the axis. To optimize the cross sectional shape of the side lip, T₁/T₃ is set to not less than 0.5 and less than 0.8 and L₂/L₁ is set to 0.2 to 0.4, where the thickness of the lip end (5c) of the side lip (5) is T₁, the thickness of the lip base (5a) is T₃, the length of the lip end (5c) is L₁, and the length of the lip base (5a) is L₂. Further, in a sealing device which includes a side lip (5) contacting with a surface angled to the axis over its contact width, the maximum value of the surface pressure in the side lip (5) is set at the most leading end (5d) of the lip.

### CROSS-REFERENCE TO RELATED APPLICATIONS

This is a national stage of the International Application No. PCT/JP2007/069545 filed on Oct. 5, 2007 and published in Japanese language.

### BACKGROUND OF THE INVENTION

1. Field of the Invention

The present invention relates to a sealing device based on a sealing technique. The sealing device in accordance with the present invention is used as a hub seal (a hub bearing seal) in a motor vehicle associated field.

2. Description of the Conventional Art

Conventionally, a sealing device 51 shown in FIG. 6 has been known. The sealing device 51 is a sealing device which is attached to an outer race 61 of a bearing and slidably comes into close contact with a rotating shaft 71. The sealing device 51 has a mounting ring 52 fixed to the outer race 61, and a rubber-like elastic body 53 attached to the mounting ring 52, and the rubber-like elastic body 53 is integrally provided with a seal lip (a side lip, hereinafter referred to as “side lip”) 54 slidably coming into close contact with an end surface portion 71a of the rotating shaft 71, and a seal lip (a radial lip) 55 slidably coming into close contact with a peripheral surface portion 71b of the rotating shaft 71.

Since the sealing device 51 has the side lip 54 slidably coming into close contact with the end surface portion 71a of the rotating shaft 71, the sealing device 51 achieves an excellent sealing effect against dust, particularly muddy water. However, optimization of a cross sectional shape of the side lip 54 has not been sufficiently investigated yet.

The conventional art is shown in Japanese Unexamined Patent Publication No. 2004-150484.

### SUMMARY OF THE INVENTION

### Problem to be Solved by the Invention

The present invention is made by taking the point mentioned above into consideration, and an object of the present invention is to optimize a sectional shape of a side lip, that is, a seal lip coming into contact with a surface having an angle with respect to a shaft, and a specific object of the present invention is to thus provide a sealing device having a seal lip which achieves an extremely excellent sealing effect against muddy water.

### Means for Solving the Problem

In order to achieve the object mentioned above, in accordance with a first aspect of the present invention, there is provided a sealing device having a seal lip coming into contact with a surface forming an angle with respect to a shaft, wherein T₁/T₃ is set to be equal to or more than 0.5 and less than 0.8, and L₂/L₁ is set to be equal to or more than 0.2 and equal to or less than 0.4 (i.e. 0.5≦T₁/T₃<0.8, and 0.2≦L₂/L₁≦0.4), where T₁is a thickness of an end portion of the seal lip, T₃is a thickness of a root portion of the lip, L₁is a length of the end portion of the lip, and L₂is a length of the root portion of the lip.

Further, in accordance with a second aspect of the present invention, there is provided the sealing device as recited in the first aspect, wherein the seal lip comes into contact with the surface forming an angle with respect to the shaft with a contact width, and a maximum value of surface pressure in the seal lip is set at a lip end of the lip.

### EFFECT OF THE INVENTION

In the structure of the first aspect mentioned above, T₁/T₃is a lip thickness ratio between the end portion of the lip and the root portion of the lip, and L₂/L₁is a lip length ratio between the root portion of the lip and the end portion of the lip. If the end portion of the lip is too thin or the root portion of the lip is too short, the lip bends too much and the surface pressure runs short, thereby causing a leakage. Further, on the contrary, if the end portion of the lip is too thick or the root portion of the lip is too long, the lip does not sufficiently bend and the surface pressure becomes too much, thereby causing a leakage due to a sliding abrasion. A middle optimum range is equal to or more than 0.5 and less than 0.8 in T₁/T₃, and equal to or more than 0.2 and equal to or less than 0.4 in L₂/L₁, as mentioned above.

Therefore, in accordance with the present invention which optimizes the lip thickness ratio between the end portion of the lip and the root portion of the lip, and the lip length ratio between the root portion of the lip and the end portion of the lip, since the contact surface pressure of the seal lip is suitably set, it is possible to achieve an extremely excellent sealing performance or resistance against muddy water.

Further, since the seal lip generally comes into contact with the other member with a predetermined contact width, a state of the surface pressure distribution within the range of the contact width greatly affects the sealing performance. With regard to this point, in accordance with a new knowledge of the inventors of the present invention, the sealing performance becomes good when the maximum value of the surface pressure in the seal lip is set at the lip end of the lip as described in the second aspect. Accordingly, it is possible to achieve the extremely excellent sealing performance or resistance against muddy water by thus optimizing the surface pressure distribution within the contact width of the seal lip.

### BRIEF EXPLANATION OF DRAWINGS

FIG. 1 is a sectional view of a substantial part of a sealing device in accordance with an embodiment of the present invention;

FIG. 2 is a schematic view of a section of a side lip in the sealing device;

FIG. 3A is a schematic view of a section of a sample 1 in a muddy water leakage test, FIG. 3B is a schematic view of a section of a sample 2, FIG. 3C is a schematic view of a section of a sample 3, and FIG. 3D is a schematic view of a section of a sample 4;

FIG. 4A is a graph showing a surface pressure distribution of a lip end in the sample 1, and FIG. 4B is a graph showing a surface pressure distribution of a lip end in the sample 2;

FIG. 5A is a graph showing a surface pressure distribution of a lip end in the sample 3, and FIG. 5B is a graph showing a surface pressure distribution of a lip end in the sample 4; and

FIG. 6 is a sectional view of a substantial part of a sealing device in accordance with a conventional art.

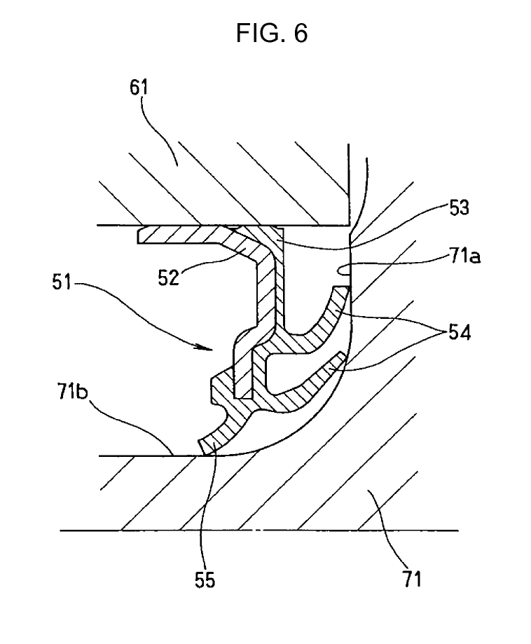

### DETAILED DESCRIPTION OF PREFERRED EMBODIMENT

Next, a description will be given of an embodiment in accordance with the present invention with reference to the accompanying drawings.

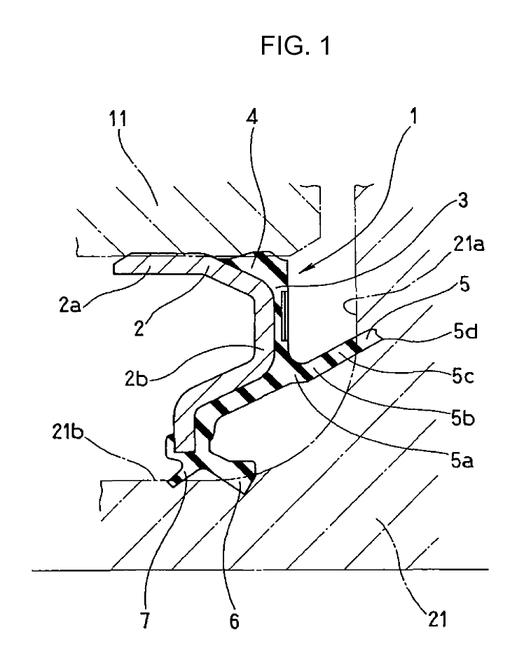

FIG. 1 shows a section of a substantial part of a sealing device 1 in accordance with an embodiment of the present invention. The sealing device 1 in accordance with the present embodiment is used as a hub seal (a seal for a hub bearing) in a bearing portion, for example, in a wheel suspension device for a motor vehicle, and is structured as follows.

First, there is provided a metal mounting ring (a metal ring) 2 fixed to an outer race 11 corresponding to a mounting member (a housing) in the bearing portion, and a rubber-like elastic body 3 is attached (bonded by vulcanization) to the mounting ring 2. The mounting ring 2 is structured such that an inward flange portion 2b is integrally formed at one end in an axial direction of a tubular portion 2a fitted to an inner peripheral surface of the outer race 11 so as to be directed to an inner side in a radial direction. The rubber-like elastic body 3 is attached to the mounting ring 2, mainly to an end surface of the flange portion 2b, and integrally has an outer peripheral seal portion 4 statically coming into close contact with the inner peripheral surface of the outer race 11, a seal lip (a side lip, hereinafter referred to as “side lip”) 5 slidably coming into close contact with an end surface portion (a surface) 21a of a rotating shaft (a shaft) 21, a seal lip (a radial lip) 6 slidably coming into close contact with a peripheral surface portion (an outer peripheral surface) 21b of the rotating shaft 21, and a sub lip (a radial lip) 7, as constructing elements. Although only one side lip 5 is provided in the figure, a plurality of side lips may be provided. As for the rotating shaft 21, the end surface portion 21a and the peripheral surface portion 21b are integrally formed in the figure, however, a metal ring (a slinger, not shown) having an end surface portion may be independently fitted to the normal rotating shaft 21 having the peripheral surface portion 21b. Further, the end surface portion 21a is not necessarily formed as a plane perpendicular to the axis, but may be formed as a surface forming an angle with respect to the axis (the central axis).

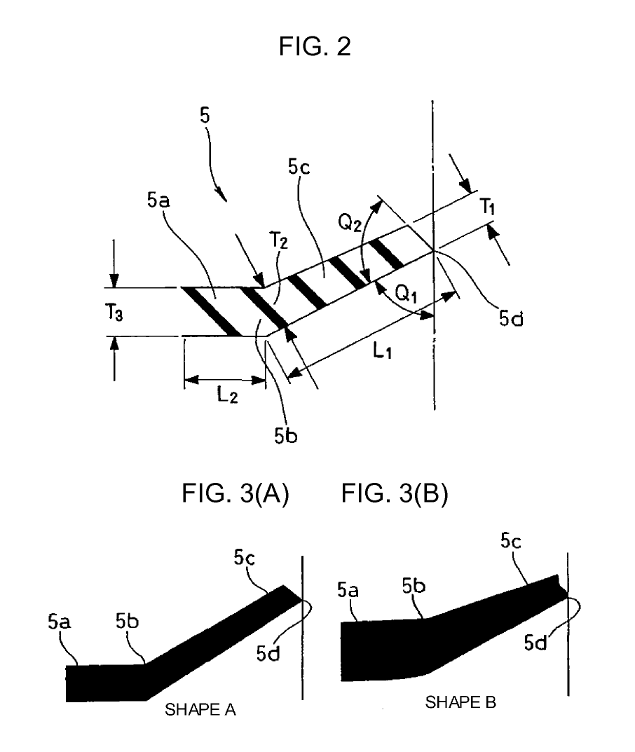

As mentioned above, the present invention aims at the optimization of the sectional shape of the side lip 5, and the side lip 5 in the present embodiment is structured, as shown enlargedly in a schematic view in FIG. 2, such that an end portion 5c is integrally formed at the distal end side (a right end side in the figure) of a root portion 5a via a bent portion (inflected portion) 5b. The root portion 5a of the lip is formed in an approximately cylindrical surface shape, and has predetermined thickness T₃ and length L₂. The end portion 5c of the lip is formed in a conical surface shape in such a manner that its diameter is enlarged little by little from its proximal end (a left end in the figure) at the root portion 5a side toward the distal end (a right end in the figure), and a predetermined slope angle Q₁ is set with respect to the plane perpendicular to the axis. Further, the end portion 5c is formed in such a manner that its thickness becomes smaller little by little from its proximal end toward the distal end, that is, a relation T₂>T₁is established, where T₂is a thickness at its proximal end and T₁is a thickness at the distal end. “Thickness T₁of the end portion of the lip” described in the first aspect of the present invention means the thickness T₁at the distal end, which is the smaller one. Further, when the root portion 5a is formed in such a manner that its thickness becomes smaller little by little from its proximal end toward its distal end, “thickness T₃of the root portion of the lip” described in the first aspect of the present invention means the thickness T₃at the proximal end, which is the larger one. Further, the end portion 5c has a lip end 5d having a predetermined tip angle Q₂at its distal end, and a surface portion adjacent to the lip end 5d in the inner peripheral surface of the end portion 5c of the lip comes into contact with the end surface portion 21a of the rotating shaft 21.

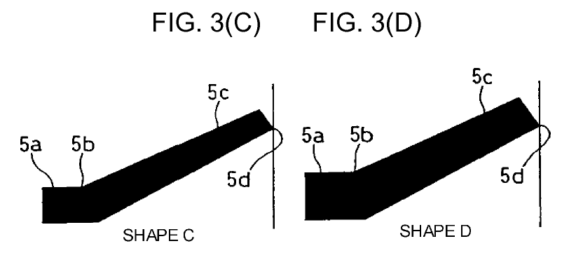

As mentioned above, the lip thickness ratio T₁/T₃ between the end portion 5c of the lip and the root portion 5a of the lip and the lip length ratio L₂/L₁ between the root portion 5a of the lip and the end portion 5c of the lip greatly affect the sealing performance, and if the end portion 5c of the lip is too thin or the root portion 5a of the lip is too short, the lip 5 bends too much and the contact surface pressure runs short, thereby causing a leakage. On the contrary, the end portion 5c of the lip is too thick or the root portion 5a of the lip is too long, the lip 5 can not sufficiently bend and the contact surface pressure becomes too large, so that a sliding abrasion is promoted, thereby causing a leakage. Regarding to this point, in accordance with a knowledge obtained by a muddy water leakage test carried out by the inventors of the present invention, if T₁/T₃ is set to a range which is equal to or more than 0.5 and less than 0.8, and L₂/L₁ is set to a range which is equal to or more than 0.2 and equal to or less than 0.4, the muddy water leakage does not occur, and a good result can be obtained. One example of the muddy water leakage test is shown as follows.

[sample 1] shape A . . . the thickness T₁at the lip end of the side lip 5 is set to 0.3 mm, the thickness T₃at the root of the lip is set to 0.55 mm, the length L₁of the end portion 5c of the lip is set to 2.5 mm, the length L₂of the root portion 5a of the lip is set to 0.9 mm, T₁/T₃ is set to 0.545, and L₂/L₁ is set to 0.360 (refer to FIG. 3A).

[sample 2] shape B . . . the thickness T₁at the lip end of the side lip 5 is set to 0.38 mm, the thickness T₃at the root of the lip is set to 0.65 mm, the length L₁of the end portion 5c of the lip is set to 1.85 mm, the length L₂of the root portion 5a of the lip is set to 1.2 mm, T₁/T₃ is set to 0.58, and L₂/L₁ is set to 0.65 (refer to FIG. 3B).

[sample 3] shape C . . . the thickness T₁at the lip end of the side lip 5 is set to 0.3 mm, the thickness T₃at the root of the lip is set to 0.45 mm, the length L₁of the end portion 5c of the lip is set to 2.5 mm, the length L₂of the root portion 5a of the lip is set to 0.7 mm, T₁/T₃ is set to 0.667, and L₂/L₁ is set to 0.280 (refer to FIG. 3C).

[sample 4] shape D . . . the thickness T₁at the lip end of the side lip 5 is set to 0.45 mm, the thickness T₃at the root of the lip is set to 0.6 mm, the length L₁of the end portion 5c of the lip is set to 2.5 mm, the length L₂of the root portion 5a of the lip is set to 1 mm, T₁/T₃ is set to 0.750, and L₂/L₁ is set to 0.400 (refer to FIG. 3D).

[Test Condition and Result]

As a result that each of the samples 1 to 4 was used for sealing under use condition in an actual device, muddy water leakage did not occur after an elapse of fifty hours and after an elapse of one hundred hours in any of the samples 1, 3 and 4, as shown in the following Table 1. On the contrary, the muddy water leakage occurred after an elapse of only fifty hours in case of the sample 2.

TABLE 1

| | | | | | | | muddy water test result | | |
|---|---|---|---|---|---|---|---|---|---|
| | size (mm) | | | | | | | one hundred | |
| | T₁ | T₃ | L₁ | L₂ | T₁/T₃ | L₂/L₁ | fifty hours | hours | judgment |
| sample 1 | 0.3 | 0.55 | 2.5 | 0.9 | 0.545 | 0.360 | ◯ | ◯ | ◯ |
| (shape A) | | | | | | | | | |
| sample 2 | 0.38 | 0.65 | 1.85 | 1.2 | 0.58 | 0.65 | X | X | X |
| (shape B) | | | | | | | | | |
| sample 3 | 0.3 | 0.45 | 2.5 | 0.7 | 0.667 | 0.280 | ◯ | ◯ | ◯ |
| (shape C) | | | | | | | | | |
| sample 4 | 0.45 | 0.6 | 2.5 | 1 | 0.750 | 0.400 | ◯ | ◯ | ◯ |
| (shape D) | | | | | | | | | |

In all the samples 1, 3 and 4 having the good results, both the lip thickness ratio T₁/T₃ and the lip length ratio L₂/L₁ exist within the ranges of 0.5≦T₁/T₃<0.8, and 0.2≦L₂/L₁≦0.4 of the present invention.

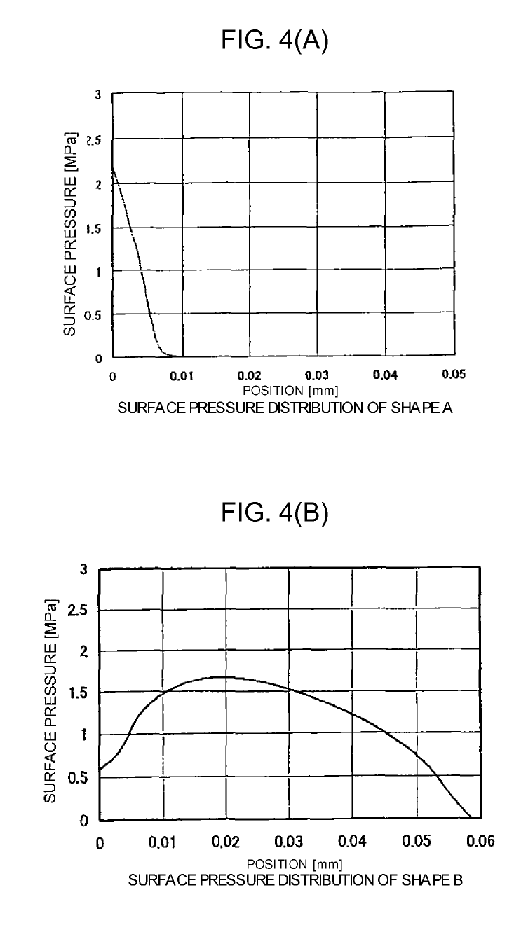

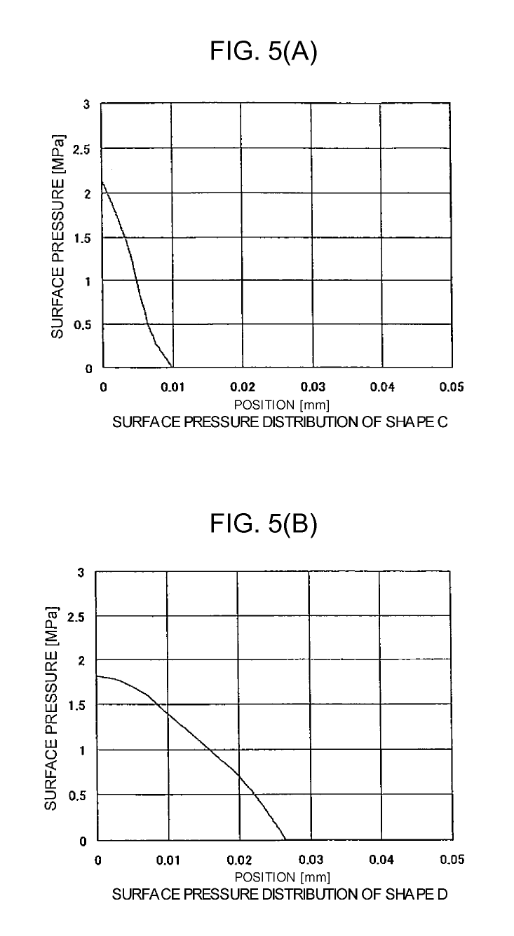

Further, with respect to the samples 1 to 4 (the shapes A to D), graphs in FIGS. 4 to 5 are obtained by measuring the surface pressure distribution of the side lip 5 in accordance with an FEM analysis. From the graphs, it is known that the maximum value of the surface pressure (the contact surface pressure of the side lip 5 with respect to the end surface portion 21a of the rotating shaft 21) exists at the lip end 5d of the lip in the samples 1, 3 and 4 in which the result of the leakage test is good (in each of the graphs, a graph horizontal axis indicates a contact width from the lip end 5d of the lip, and a point at 0 mm position corresponds to lip end 5d of the lip). Accordingly, it is possible to improve a sealing performance or a resistance against muddy water of the side lip 5 by setting such that the maximum value of the surface pressure of the side lip 5 is positioned at the lip end 5d of the lip, on the basis of the new knowledge.

In this case, it is preferable that the surface pressure is not less than 0.5 MPa and less than 3.5 MPa. If it is less than 0.5 MPa, the leakage caused by lack of the surface pressure occurs, and if it is not less than 3.5 MPa, a lip abrasion is promoted, and causes the leakage. It is further preferable that the surface pressure is in the range of not less than 1.5 MPa and less than 2.5 MPa.

Further, it is preferable that the contact width is equal to or more than 0.005 mm and less than 0.03 mm. If it is less than 0.005 mm, the surface pressure becomes too high and a stress is concentrated on the lip end, whereby the abrasion makes progress. As a result, the leakage is caused. Further, if it is equal to or more than 0.03 mm, the maximum value of the surface pressure is generated at the other position than the lip end (the lip end 5d of the lip). As a result, a seal reliability becomes lowered.

1. A sealing device having a seal lip coming into contact with a surface forming an angle with respect to a shaft, wherein T₁/T₃ is set to be equal to or more than 0.5 and less than 0.8, and L₂/L₁ is set to be equal to or more than 0.2 and equal to or less than 0.4, where T₁is a thickness of an end portion of said seal lip, T₃is a thickness of a root portion of the lip, L₁is a length of the end portion of the lip, and L₂is a length of the root portion of the lip.

2. The sealing device as claimed in claim 1, wherein the seal lip comes into contact with the surface forming an angle with respect to the shaft with a contact width, and a maximum value of surface pressure in said seal lip is set at a lip end of the lip.
